(19) United States
(12) Patent Application Publication
(10) Pub. No.: US 2024/0046815 A1
(43) Pub. Date: Feb. 8, 2024

(54) HANDHELD DEVICE FOR FACILITATING PERSONAL DEVELOPMENT AND COMMUNICATION

(71) Applicant: Cedric Riley, Bronx, NY (US)

(72) Inventor: Cedric Riley, Bronx, NY (US)

(21) Appl. No.: 18/228,930

(22) Filed: Aug. 1, 2023

Related U.S. Application Data
(60) Provisional application No. 63/370,442, filed on Aug. 4, 2022.

(51) Int. Cl. G09B 19/00; G06K 15/00; G06F 3/04886; G06F 3/041

(52) U.S. Cl. CPC G09B 19/00; G06K 15/002; G06F 3/04886; G06F 3/0416; G06F 2203/04105

(57) ABSTRACT

A mobile device for promoting communication and personal development amongst children within a foster care system. The mobile device provides alternative ways for a user to express their emotions and feelings without having to speak. The mobile device also provides a personal development program and tracks the users progress and incentivizes progress by rewarding the user with a digital coin for each module the user completes.

### CROSS REFERENCES TO RELATED APPLICATIONS

This application is related to and claims priority to and the benefit of U.S. Provisional Application No. 63/370,442, filed on Aug. 4, 2022 which is incorporated herein by reference in its entirety.

### BACKGROUND OF THE INVENTION

### 1. Field of the Invention

The present invention relates to personal development, and more specifically to systems and methods for relationship building, communication, personality and identity development and recordation, and personal development and recordation through a device with multiple tactile inputs.

### 2. Description of the Prior Art

It is generally known in the prior art to provide training and personal development systems and methods.

Prior art patent documents include the following:

US Patent Publication No. 2007/0033082 for Methods and systems for promoting positive youth development by inventors Hilliard, et al., filed Jul. 18, 2006 and published Feb. 8, 2007, is directed to a method for promoting positive youth development using a computer system coupled to a database is provided. The method includes selecting youths for inclusion in a youth development program by applying a pre-determined selection criteria to data stored within the database, providing a development plan to each selected youth wherein the development plan includes a set of goals to be achieved over a specific period of time and a set of tasks to be performed to facilitate achieving the set of goals, monitoring the selected youth within a residential summer camp portion of the youth development program, tracking and monitoring family and community service involvement by the selected youth outside of the summer camp portion of the development program, tracking and monitoring continuing education expectations of the selected youth, and verifying an ongoing connection between the selected youth and youth development program staff for a predetermined period of time.

U.S. Pat. No. 9,533,227 for Systems and methods in support of providing customized gamification for accomplishing goals by inventor Chelst, filed Mar. 17, 2014 and issued Jan. 3, 2017, is directed to a method in support of providing customized gamification for accomplishing goals receives a request to generate a game framework, the request specifying a goal to be accomplished by one or more participants of a plurality of participants, at least in part through interaction with the game framework. A first set of one or more game parameters to be applied to the game framework is determined for at least a first participant of the plurality of participants, and the game framework comprising the first set of one or more game parameters is generated. The game framework comprising the first set of one or more game parameters is applied to a first profile relating to the first participant of the plurality of participants. The game framework can then be provided to an electronic computing device of the first participant over the network. Systems can be constructed to implement the methods described herein.

U.S. Pat. No. 8,351,773 for Motion sensing and processing on mobile devices by inventors Nasiri, et al., filed Mar. 11, 2011 and issued Jan. 8, 2013, is directed to handheld electronic devices including motion sensing and processing. In one aspect, a handheld electronic device includes a set of motion sensors provided on a single sensor wafer, including at least one gyroscope sensing rotational rate of the device around at least three axes and at least one accelerometer sensing gravity and linear acceleration of the device along the at least three axes. Memory stores sensor data derived from the at least one gyroscope and accelerometer, where the sensor data describes movement of the device including a rotation of the device around at least one of the three axes of the device, the rotation causing interaction with the device. The memory is provided on an electronics wafer positioned vertically with respect to the sensor wafer and substantially parallel to the sensor wafer. The electronics wafer is vertically bonded to and electrically connected to the sensor wafer.

U.S. Pat. No. 11,100,785 for Method for requesting assistance from emergency services by inventor Cougar, filed Jan. 15, 2021 and issued Aug. 24, 2021, is directed to a method of requesting assistance from emergency services employs an electronic actuator that is preconfigured to communicate with authorities in the event that the actuator is used. An electronic signal is relayed from the device to remote servers, where machine learning and artificial intelligence logic is applied to the signal, before relaying a signal to the most appropriate authorities. The electronic signal may include information such as identifying and location information. The signal may also utilize various sensors or detectors, such as cameras, accelerometers, light sensors, pressure sensors, and more in order to collect and relay additional data. The response is then relayed to the authorities, who may continue to receive information about the user while in transit. In this way, the method of requesting assistance from emergency services provides security for people who may encounter emergency situations in which they cannot use a phone or mobile device.

U.S. Pat. No. 11,081,238 for Interactive graphical user interfaces for implementing personalized health and wellness programs by inventors Damani, et al., filed Dec. 20, 2017 and issued Aug. 3, 2021, is directed to user-specific medical, genetic, fitness, environmental and nutritional data is collected to develop personalized health and wellness programs for improving a user's health and wellness. The user-specific data may be collected from medical or genetic tests, mobile health devices worn by the user and applications through which the user manually inputs information. The user-specific data is then collected and analyzed together based on knowledge of the interrelationships between medical, genetic, fitness, environmental and nutrition data to develop a comprehensive user profile and personalized health and wellness programs that are targeted to improving specific areas of the user's health by implementing changes in fitness, nutrition, medical treatment, environment, etc. The user is provided with a customizable, interactive dashboard graphical user interface of their current health and wellness data, which, along with notifications, incentives and rewards, helps the user improve their overall health and wellness and significantly reduce their risk of morbidity.

U.S. Pat. No. 10,362,940 for Personal emergency response (per) system by inventor Tran, filed Aug. 23, 2017 and issued Jul. 30, 2019, is directed to a system includes one or more sensors to detect activities of a mobile object; and a processor coupled to the sensor and the wireless transceiver to classify sequences of motions into groups of similar postures each represented by a model and to apply the models to identify an activity of the object.

### SUMMARY OF THE INVENTION

The present invention relates to communication devices, and more specifically communication devices for young individuals who are isolated and/or facing personal challenges such as uncertainty around their identity and heritage and a lack of stability, such as young individuals in the foster care system.

It is an object of this invention to provide a device that is designed to create an immersive virtual ecosystem for youth behavioral training and character development as well as promoting users to express their emotions through alternative methods.

In one embodiment, the present invention is directed to a device for enabling nonverbal communication.

In another embodiment, the present invention is directed to a device for creating an immersive virtual ecosystem to encourage personal development.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates an orthogonal front view of a mobile training device according to one embodiment of the present invention.

FIG. 2 illustrates an orthogonal front view of a mobile training device according to one embodiment of the present invention.

FIG. 3A illustrates an orthogonal front view of a mobile training device according to one embodiment of the present invention.

FIG. 3B illustrates an orthogonal front view of a mobile training device according to one embodiment of the present invention.

FIG. 4 illustrates an orthogonal front view of a mobile training device according to another embodiment of the present invention.

FIG. 5 illustrates an orthogonal front view of an action die.

FIG. 6 illustrates an orthogonal back view of a mobile training device according to one embodiment of the present invention.

FIG. 7 illustrates an orthogonal back view of a mobile training device according to another embodiment of the present invention.

FIG. 8 is a schematic diagram of a system of the present invention.

### DETAILED DESCRIPTION

The present invention relates to communication devices, and more specifically communication devices for young individuals who are isolated and/or facing personal challenges such as uncertainty around their identity and heritage and a lack of stability, such as young individuals in the foster care system.

In one embodiment, the present invention is directed to a device for enabling nonverbal communication.

In another embodiment, the present invention is directed to a device for creating an immersive virtual ecosystem to encourage personal development.

None of the prior art discloses a device for creating an immersive virtual ecosystem for training and developing positive behavior in a user while allowing the user to express their emotions through nonverbal methods. In addition, none of the prior art discloses systems and methods for taking inputs from a user to assess their progress as well as reward progress during training modules. Advantageously, this provides a more accurate assessment of a user's emotional, behavioral, and personal development and allows for the creation of a record of the personality of the user and progress towards development goals.

More than twenty-three thousand children will age out of the US foster care system every year and only one out of two foster kids who age out of the foster care system will have some form of gainful employment by the age of twenty-four. Furthermore, ninety percent of youth with five or more foster placements will enter the justice system, with somewhere between thirty to forty percent of foster children having been arrested since exiting foster care. Overall, the foster care system fails to provide children within the system with the relationships and connections necessary to learn social and life skills that will prepare the children for adulthood. There is currently no measurable way for foster parents, guardians, and other relevant personnel in the foster care system to provide evidence of the steps that have been taken to nurture and develop children in the custody of the foster care system. Additionally, it is not uncommon for children in the foster care system to have different caretakers throughout their time in the foster care system. A new caregiver does not currently have a record of the child's development, the child's personality, or typical behavior for the child, which affects the caregiver's ability to interact with and care for the child. Children in the foster care system consequently do not have a consistent relative or other adult who cares about their well-being. The lack of consistency leads to a lack of a communication about the child to the child's caregiver, and the lack of a consistent response to a child's desires, thoughts, emotions, and actions from the caregiver. Children often do not have any contact with relatives, and the child does not have an adequate understanding of the personalities, preferences, or values of their relatives, including their parents, grandparents, siblings, etc. after the child enters the foster care system. This leads to a lack of confidence in identity and uncertainty around the child's heritage. What is needed is a device for foster children to allow for discovering and creating an identity, encouraging communication, and developing positive behavior. Prior art documents, such as U.S. Patent Pub. No. 2007/0033082, disclose computer platforms for promoting youth development by setting goals and creating steps to achieving those goals but don't disclose a device that creates an immersive ecosystem that promotes and incentivizes personal development with digital credit while also enabling a user to nonverbally express their emotions and connect with the personalities of their relatives while also documenting their own personality, emotions, and thoughts. Additionally, personal development for foster care children currently often includes paper worksheets, which are easily lost or destroyed.

The present invention provides a mobile device with multiple inputs and displays which provides a record of a child, including the development of the child, the personality of the child, and the preferences of the child. The device provides the child a device through which the child is able to communicate their wants and needs and achieve progress towards goals and personal development, while also providing access to information about heritage and relatives of the child. Foster parents or guardian devices are able to access the information associated with the child to better serve the development and needs of the child, which is especially important when the child is moved to a new environment such as a new foster home or is assigned a different foster parent.

Referring now to the drawings in general, the illustrations are for the purpose of describing one or more preferred embodiments of the invention and are not intended to limit the invention thereto.

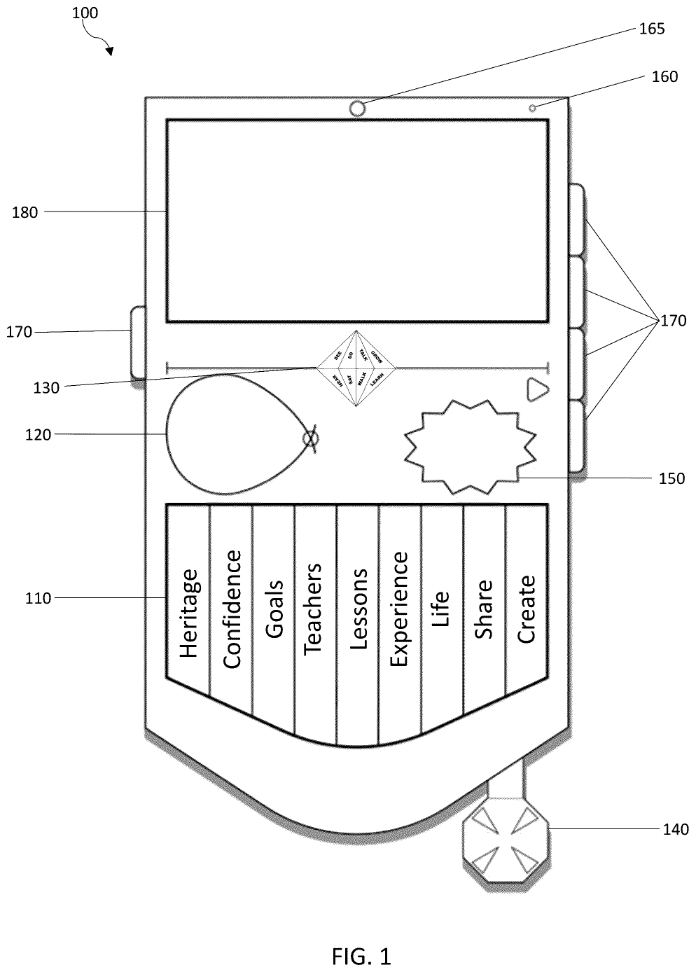

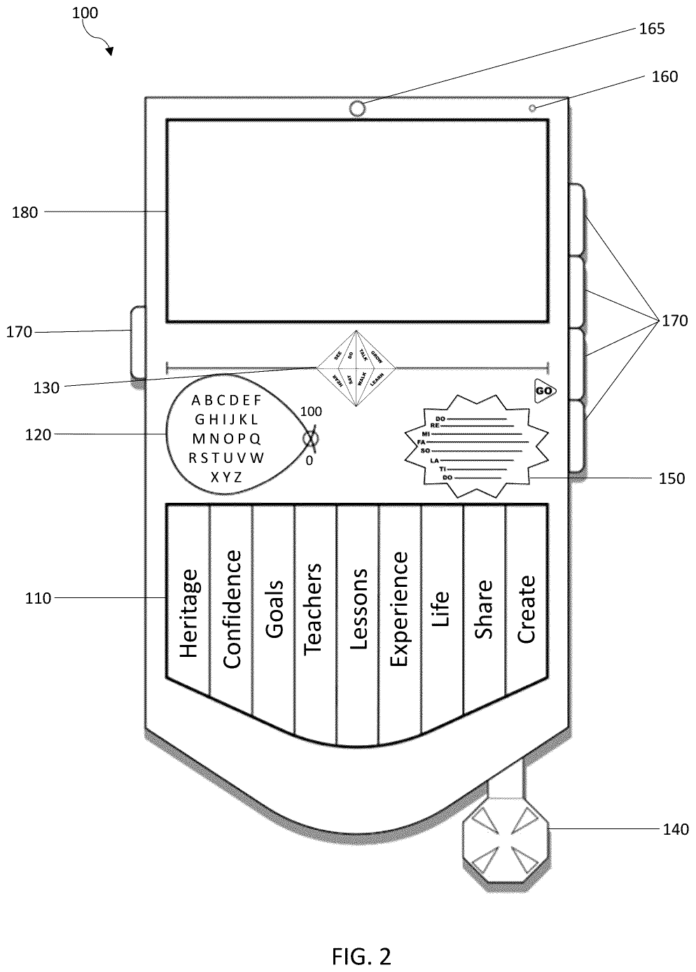

FIGS. 1-4 illustrate the front of a mobile device 100 including a housing, a processor, a memory, and software according to one embodiment of the invention. The mobile device 100 includes a primary touch screen 180, a secondary touch screen 120, a lock 140, a tertiary touch screen 150, an action die 130, five pressure buttons 170, a camera 160, a light emitting diode (LED) indicator 165, and a hard touch button panel 110. The primary touch screen 180, secondary touch screen 120, and tertiary touch screen 150 provide different input mechanisms to capture emotions of a user of the device. Different people often have different strengths and preferences in communication. For example, some people communicate verbally most effectively, while others prefer to communicate via music or images. The primary touch screen 180 is located at the top of the mobile device and is surrounded by a bezel. The primary touch screen 180 displays the progress of the user throughout their personal development, which is visually represented as an empowerment bridge, and acts as an interface for users to select options that are presented on the screen.

A secondary touch screen 120 is located beneath the primary touch screen 180 and is designed to be a user interface. In a preferred embodiment the secondary touch screen 120 is operable to display a keyboard for receiving alphanumeric or alphabetical inputs from a user, which is advantageous for allowing the user to express how the user is feeling without having to speak. Alternatively, the keyboard is used for receiving inputs for answering questions that are presented on the primary touch screen 180. In an alternative embodiment, the secondary touch screen 120 is operable to display a color palette. The color palette provides an alternative method for receiving user inputs which enable the user to express emotions without using words. For example, if the user is feeling sad, the color palette provides for selection of the color blue from the color palette to express that specific feeling. In another embodiment, the secondary touch screen 120 includes a dial that rotates clockwise around the secondary touch screen 120. The dial starts at level zero and can be rotated to level one hundred. By providing for a numerical input in connection with another input, such as a color or alphanumeric or alphabetical characters, the present invention provides a way to receive inputs correlating with how strongly a user feels about the input entered on the secondary touch screen. For example, if the user wants to express that the user is feeling extremely unmotivated, the device is operable to receive an input of the word unmotivated via alphanumeric or alphabetical inputs on the secondary touch screen and rotation of the dial to an appropriate level, such as level eighty. A device associated with a foster parent, a guardian, or other connection is operable to receive the communication from the device of the foster child, which indicates that the foster child is feeling unmotivated and is an urgent matter based on the level associated with the input. In another example, the mobile device 100 is operable to receive a request, such as inputs of mentor, hug, or walk so that a foster parent or guardian is able to identify and respond to a specific request of the foster child.

The tertiary touch screen 150 is located to the right of the secondary touch screen 120 and beneath the primary touch screen 180. In a preferred embodiment the tertiary touch screen 150 is operable to display a musical input interface including a musical scale, which enables for composition of music for expression of emotions through music. In an alternative embodiment, the tertiary touch screen 150 is operable to display emojis or other images, which enable expression of emotions in a visual form. Advantageously, this provides another method for the user to express their emotions. In another embodiment the mobile device 100 uses the tertiary screen 150 as tool for teaching the user colloquy lessons and how to react in certain situations. The musical scale (Do, Re, Mi, Fa, So, La, Ti, Do) is used as a mnemonic to help users respond to certain situations either occurring in real life or simulated on the primary touch screen 180. The musical note “Do” is pronounced “doh” and is used as mnemonic for dough, which is a colloquial term for money, this encourages the user to assess a situation and make an informed decision that will best benefit the financial situation of the user. The musical note “Re” is a mnemonic for ray which is intended to motivate a user to have a bright outlook on a situation. The musical note “Mi” is pronounced the same as the word me and is used to help the user think about their self-image during a situation. The musical note “Fa” is a mnemonic for the word far, this is used to help the user think about how far this situation or decision will affect the life of the user. The musical note “So” is a mnemonic for the word sew which will help the user think about ways to repair, mend, or proceed during a difficult situation. The musical note “La” is a mnemonic device for the word law, and encourages the user to think about the laws that pertain to a situation the user is involved in. The musical note “Ti” is a mnemonic for the word tea, this is used to help remind the user to set up a time to discuss a difficult situation with a foster parent or guardian, similar to setting a tea time. The last musical note is “Do” and is a mnemonic for the word “do”, this is a suggestion that is provided to the user on what the user should do in a certain situation after taking everything into account. Each musical note displayed on the tertiary touch screen 150 is highlighted with a specific color to help the user remember all the mnemonic devices. In one embodiment, “Do” is highlighted red, “Re” is highlighted yellow, “Mi is highlighted blue, “Fa” is highlighted orange, “So” is highlighted brown, “La” is highlighted green, “Ti” is highlighted purple, and “Do” is highlighted gold. In one embodiment, the tertiary screen 150 is shaped in a star, with each point in the star representing points made during the colloquy lesson. The tertiary touch screen 150 is backlit with red, green, and blue light emitting diodes (LEDs). The LEDs are operable to change color in real time depending on which musical note is highlighted in the colloquy lesson. For example, if the user is focusing on the musical note “Ti” then the LEDs emit the color purple. Similarly, if the colloquy lesson focuses on the musical note “So” then the LEDs emit the color gold. The horizontal lines extending from the musical notes that are displayed on the tertiary touch screen 150 are used to display vocabulary or key words that are relevant to that musical note. For example, the first musical note “Do” has the word debt next to it while the musical note “Re” might have the word optimistic next to it. This vocabulary is used to help the user articulate whatever thoughts they might have during a situation. For example, if the user is presented with a situation where a friend is lending the user money then the user can associate the word debt with that situation which helps the user understand that accepting that money will put the user in debt. In one embodiment, these lessons are incorporated into nine suites: heritage, confidence, goals, teacher, lessons, experience, life, share, and create. The nine suites can be found on the primary touch screen 180 in the empowerment bridge or at the bottom of the mobile device 100 on the hard touch button panel 110.

The camera 160 is located at the top right of the mobile device above the main touch screen 180 and is fitted into the bezel that surrounds the main touch screen. The camera 160 is operable to capture a picture or a video of a user. After the camera 160 has captured a picture or video of a user, the mobile device is operable to transmit the picture or video to a device belonging to a foster care parent or guardian within the network of the user device in real time. This is advantageous for providing the user with an alternative method of expressing their emotional state to their foster care parent or guardian. For example, if an image or video of a user shows the user frowning or crying, this indicates the user is feeling sad or depressed. Alternatively, if the image or video of the user shows the user laughing, smiling, or playing, this indicates the user is happy or feeling playful.

The lock 140 is located at the bottom right of the mobile device 100 and is designed to prevent unauthorized users from accessing or operating the device. The lock 140 is operable to be unlocked to access the device in a variety of ways known in the art. In one embodiment, the lock 140 is operable to be opened by a physical key. In an alternative embodiment, the lock 140 is a digital lock and is unlocked using an RFID chip. In yet another embodiment, the lock 140 is a biometric sensor and is unlocked using a biometric input from an authorized user, such as a fingerprint or a retinal scan.

The hard touch button panel 110 is located on the bottom half of the mobile device 100, beneath the secondary touch screen 120 and tertiary touch screen 150. The hard touch button panel 110 includes hard touch buttons, with each button including a label for a different suite. In one embodiment, the hard touch button panel 110 includes nine different buttons representing nine different suites. The nine different suites are heritage, confidence, goals, teachers, lessons, experience, life, share, and create. The purpose of the hard touch button panel 110 is to provide users with another way to nonverbally express their emotional state. The device is operable to record an input each time a button is pressed by a user; the number of times the button is pressed signifies how the user is feeling regarding that suite, with the greater number of times the button is pressed representing the better that user is feeling about the suite. In one embodiment, the lowest number of recorded inputs for a particular suite is one and the maximum number of recorded inputs for a particular suite is ten. For example, if the mobile device 100 receives user input of the user pressing the confidence button seven times, the goals button nine times, and the create button four times, then the mobile device is operable to receive and transmit that input to another device showing the user is feeling seven out ten regarding their confidence, nine out of ten regarding their goals, and four out of ten regarding their creativity. The mobile device then transmits this input in real time to another device that is monitored by a foster parent, guardian, or other connection of the foster child in real time. In another example, a user feels terrible about their heritage who has a lack of an idea of where the user comes from and a lack of a relationship with a mother and father. The mobile device 100 receives an input of the heritage button being pressed once, indicating the user feels terrible or extremely negative about their heritage. This information enables the foster parent or guardian to determine that the user needs guidance on their heritage. In one embodiment, the foster parent or guardian device receives a push notification such as a text notification, mobile application notification, or email notification indicating the feeling of the user. This enables the foster parent or guardian to take an action in response to the feeling of the user. The foster parent or guardian device is preferably operable to access the record of the inputs of the user to determine a history of the feelings of the user and past issues the user has encountered to better guide the response of the foster parent or guardian. In one embodiment, the mobile device is operable to receive content related to the heritage of the user from the foster parent or guardian device, such as photos, images, videos, and/or text. This content is operable to be displayed on the primary display screen 180.

The five pressure buttons 170 are located at either side of the mobile device 100, four of which are on the right side of the mobile device and one of which is on the left side of the mobile device. Each of the five pressure buttons are located where a user would naturally place their five fingers when gripping the mobile device. Although the present application describes five pressure buttons, one of ordinary skill in the art will understand that any number of pressure buttons or any form of pressure input is operable to be utilized in connection with the device of the present invention. The five pressure buttons include pressure sensors that serve the purpose of measuring how hard a user is squeezing the mobile device in real time to provide an intensity associated with other inputs received through one or more other input mechanisms of the mobile device. Typically, when someone clinches their hand or fist, this indicates feelings of frustration, aggression, and/or anger. The ability of the device to measure how hard a user is squeezing the mobile device, such as via clinching their hand, is advantageous because it provides a method of detecting that a user is in a negative emotional state in real time. In addition, the pressure buttons provide a method for the user to express that the user is in a negative emotional state without having to explicitly indicate their negative emotional state. Each of the five pressure buttons 170 is outfitted with pressure sensors and is operable to measure how much force a user is gripping the mobile device with. The device is operable to use the gripping input from the five pressure buttons 170 and convert it to a scale of one to five, with five being a very strong gripping force and one being a very weak gripping force. Because the grip strength of a child typically increases as the child gets older the scale is adjusted depending on the age of the child. For example, thirteen pounds of force would be considered a five out of five for a ten year old user but would be considered a two out of five for a seventeen year old user. In one embodiment, one of the displays of the device displays a number indicating the number associated with the input received via the five pressure buttons 170 to provide feedback to the user about how the user is feeling. After the device converts the measured pressure to the adjusted scale, the device then transmits that data to another device that is monitored by a foster parent or guardian in real time. The five pressure buttons 170 are operable to be used in combination with the keys on the hard touch button panel 110 to associate an intensity of feeling with each of the categories on the hard touch button panel 110. For example, the mobile device 100 is operable to receive an input of one for goals and then a hard squeeze of the pressure inputs via the five pressure buttons 170 to indicate that the user is feeling very intensely negative about where the user is with goals. Advantageously, the five pressure buttons 170 operate as a mechanism to provide additional information about another input received through the mobile device 100 quickly to a foster parent or guardian. In one example, input is received through the secondary touch screen 120 that indicates that a child is considering suicide and the five pressure buttons 170 receive an input that is near or at the top of the pressure scale for the child. When the foster parent or guardian device receives a notification about this input, this quickly conveys to the foster parent or guardian device that an ambulance should be sent to the location of the foster child immediately. In one embodiment, notifications relating to inputs that indicate a serious threat to the wellbeing of the child are operable to be presented as alerts on the foster parent or guardian device. For example, a notification that a child is considering suicide causes the parent or guardian device to emit a flashing light via one or more light emitting diodes (LEDs) on the foster parent or guardian device and emit an audio alarm in combination with a text message. The alert in the form of the flashing light and the audio alarm preferably continues until manual input is received through the foster parent or guardian device to stop the alarm.

In an alternative embodiment, the pressure buttons are outfitted with a deformable rubber grip that compresses when the user squeezes the mobile device. This creates for more points of contact with the pressure sensors and provides the user with tactile feedback of how hard the user is squeezing the mobile device.

The action die 130 is located in the middle of the mobile device 100 below the primary touch screen 180 and is attached to a slider that enables the action die to slide horizontally across the device. The action die 130 is also pinned on a vertical axis that allows the action die to rotate freely about the vertical axis. The action die's ability to slide along the horizontal axis acts as an interface for the user to see the progress the user has made on their empowerment bridge. As the user slides the action die from left to right this reveals the parts of the empowerment bridge that the user has completed on the primary touch screen display.

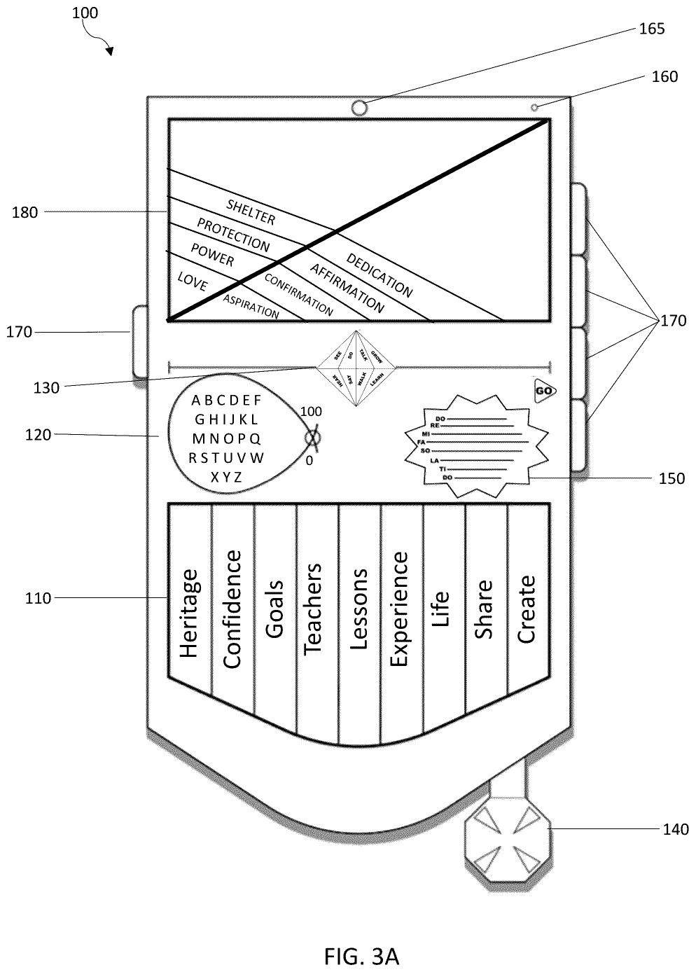

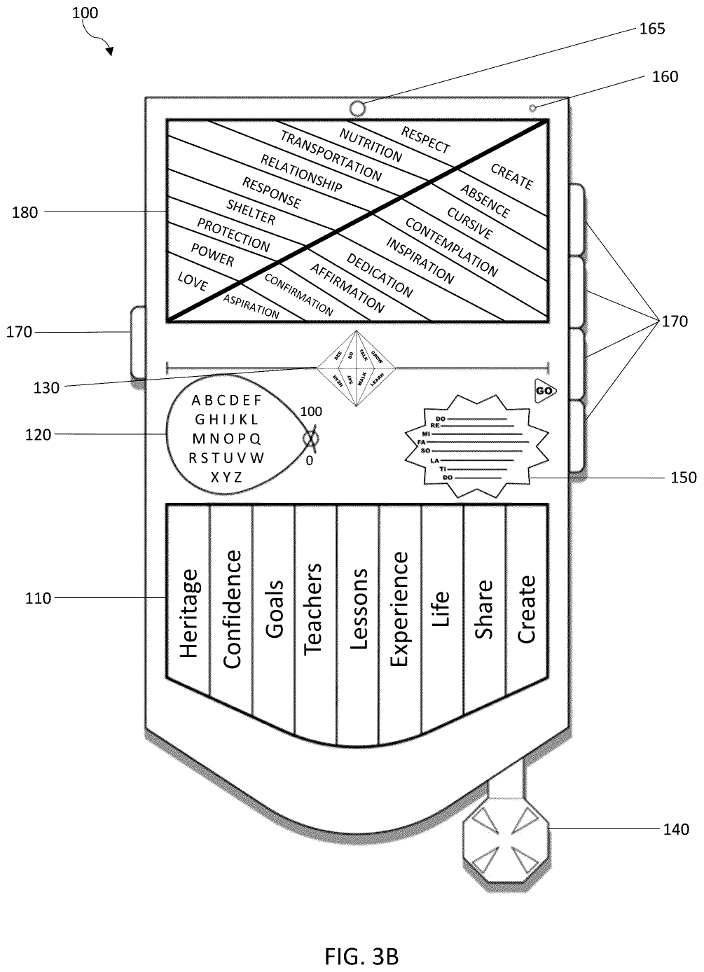

FIG. 3A illustrates the primary touch screen 180 displaying the empowerment bridge halfway complete. The empowerment bridge acts as a way of representing the user's progress throughout their personal development journey. In FIG. 3A, the empowerment bridge is halfway complete, signifying that the user has completed half of the modules thus far. Each time a user completes a module a new segment is added to the bridge. The LED indicator 165 is located in the middle of the top bezel of the mobile device 100. The relative brightness of the LED indicator 165 indicates the progress the user has made on the empowerment bridge. For example, if no segments have been completed, the LED indicator 165 does not emit any light. If a few segments have been completed, the LED indicator 165 will emit a dim light. If all segments have been completed, the LED indicator 165 will emit a bright light. In one embodiment, a color of the light emitted by the LED indicator 165 is operable to be selected through the mobile device 100. In another embodiment, the LED indicator 165 is operable to function as a flashlight and change in brightness upon receiving an input from a user to do so. In addition, the LED indicator 165 operates as a flash to support the camera 160 of the mobile device 100. For example, if the camera 160 is in use and the mobile device 100 is in a dark or dimly lit environment, then the LED indicator 165 automatically turns on to illuminate whatever is in front of the camera 160. This enables the mobile device 100 to capture high definition images in low light environments. In yet another embodiment, the LED indicator 165 changes in brightness depending on the lighting of the environment of the mobile device 100. For example, if the mobile device 100 is in a dark room, the LED indicator 165 emits a less bright light when in use. Alternatively, if the mobile device 100 is in a well-lit room, the LED indicator 165 emits a bright light to be visible to a user. FIG. 3B illustrates the primary touch screen 180 displaying the empowerment bridge fully complete, which signifies that the user has completed all the modules. Each segment of the empowerment bridge is comprised of the nine suites: heritage, confidence, goals, teachers, lessons, experience, life, share, and create. Each segment of the empowerment bridge represents one year, with each year corresponding to the length of time the user has been active on the mobile device 100. For example, if the empowerment bridge has eight segments, then that signifies to a foster parent or guardian that the user has been using the mobile device 100 for eight years. The empowerment bridge provides foster parents and guardians with metric data about how much progress the user has made in regard to developing soft skills. Traditionally, if a foster parent or guardian wanted to learn about a foster child they would have to parse through previous interviews and reports involving the foster child. This creates a false image of the foster child because there are no specific metrics involved, rather just subjective assumptions that previous foster parents and guardians had about the foster child. Similarly, a social worker currently lacks the tools to quickly assess the current state of development of a child. The empowerment bridge also provides social workers with specific data about the development of a child, enabling any social worker to quickly come up to speed on the development of the child. Accordingly, the present invention gives foster parents, guardians, and social workers convenient and quick access to data about how much progress the user has achieved with respect to developing soft skills, which is advantageous over the prior art in providing updated, real-time measurable information about a user and saving time, money, and/or effort for social workers, foster parents, and guardians in reviewing materials which traditionally have been reviewed by these parties to understand the current development and profile of a child.

Every time a user completes a segment of the empowerment bridge, the user receives digital credit that is redeemable at a physical marketplace or a virtual marketplace. In one embodiment, the digital credit is a digital currency or a virtual currency such as a cryptocurrency. To incentive completion of sections of the empowerment bridge, digital credits are operable to be redeemed for rewards such as fresh fruit, fresh vegetables, toys, books, clothes, and/or shoes. These types of rewards are particularly motivating for children in the foster care system, who often do not have stable families or guardians who regularly provide these types of goods to the child. The physical marketplace and digital marketplace are closed ecosystems in that only the digital credit or currency earned through the device are operable to be redeemed at these marketplaces. Digital credit is also operable to be earned based on other inputs received by the mobile device 100. For example, if the device receives a phrase “success is a choice” as an input through the secondary touch screen 120, software on the device is operable or software on a server computer or cloud-based platform connected to the device is operable to recognize that the phrase is a positive development for the child and reward digital credit to the digital credit account associated with the device of the child. In one embodiment, natural language processing (NLP) is utilized by an algorithm on the device, the server computer, or the cloud-based platform to determine if an input deserves digital credit and to determine how much digital credit is rewarded. Alternatively, a foster parent or guardian device is operable to award digital credit after review of the input by the foster parent or guardian. The device automatically tracks of the digital credit that is earned by the user. The digital credit program incentivizes the user to consistently work on the modules and further develop their soft skills.

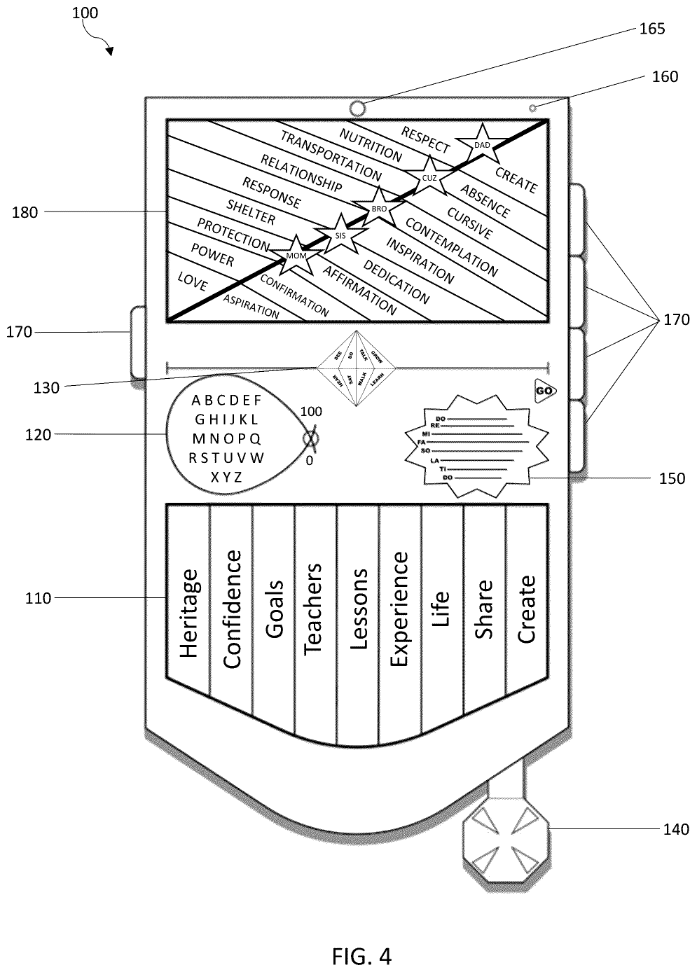

FIG. 4 illustrates the primary touch screen 180 displaying a completed empowerment bridge with the familial stars. The purpose of the familial stars is to provide the user with access to information about their family members whom the user is no longer in contact with, or family members with whom the user has infrequent contact. For example, if the user wants to hear the music that their late mother listened to, the device enables the user to select the mom star on the primary touch screen 180 and select a music icon to listen to the music their mother listened to. The device is also operable to record data about the user to create a catalogue of the user's data and a digital footprint for their descendants to learn about the user. In one embodiment, the digital footprint of ancestors or other relatives of the user include a personality, media preferences such as favorite books, movies, music, plays, art, etc., food preferences such as favorite dishes, family recipes, favorite restaurants, etc., quotes, and achievements. Media associated with the ancestor or relative, such as audio recordings, video recordings, or images of the ancestor or relative, are operable to be saved and associated with the familial star to enable the user to understand what their relative or ancestor looked like, how the relative or ancestor acted, and what the relative or ancestor sounded like. The digital footprint is operable to include a timeline for the information included in the digital footprint such that changes in personality and preferences for an ancestor or relative are associated with a specific time frame. In another embodiment, the personality or preferences of an ancestor or a relative are only able to be unlocked by a user when the user reaches a certain age. For example, a favorite alcoholic beverage of an ancestor or a relative is only operable to be unlocked by the user device when the associated user reaches the age of 21. Advantageously, the familial stars and associated profiles and information create a familial connection that many individuals in the foster care system desire but do not have access to. In one embodiment, information associated with the familial stars is stored locally on the device. Additionally or alternatively, information associated with the familial stars is stored in a database on a server computer or in a cloud-based platform the mobile device is operable to access over a network.

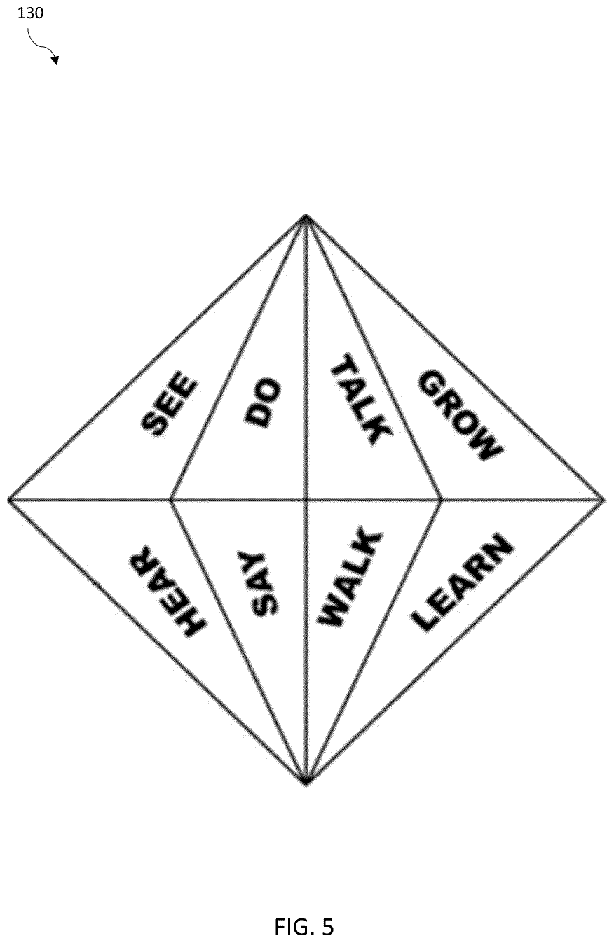

FIG. 5 illustrates an exploded view of the action die 130 with the actions see, do, talk, grow, hear, say, walk, and learn labeled on each side of the die. The action die 130 operates as another interface for the user to manipulate the primary touch screen 180. The action die 130 is operable to slide along a horizontal rail. The mobile device 100 is operable to change what appears on the primary touch screen 180 depending on where the action die is located. The primary touch screen 180 is operable to display the empowerment bridge over time, with the start of the empowerment bridge beginning on the left hand side of the primary touch screen 180 and the present point on the empowerment bridge being located on the right hand side of the primary touch screen 180. The primary touch screen 180 is preferably operable to display up to 150 years of an empowerment bridge in one embodiment. For example, if the user would like to select an earlier segment of the empowerment bridge, then the user would slide the action die to the left on the horizontal rail, while the user slides the action die to the left earlier segments of the empowerment bridge are sequentially highlighted on the primary touch screen 180. When the desired segment of the bridge is highlighted then the user can press the action die 130 down to select the segment of the empowerment bridge that is highlighted on the primary touch screen 180.

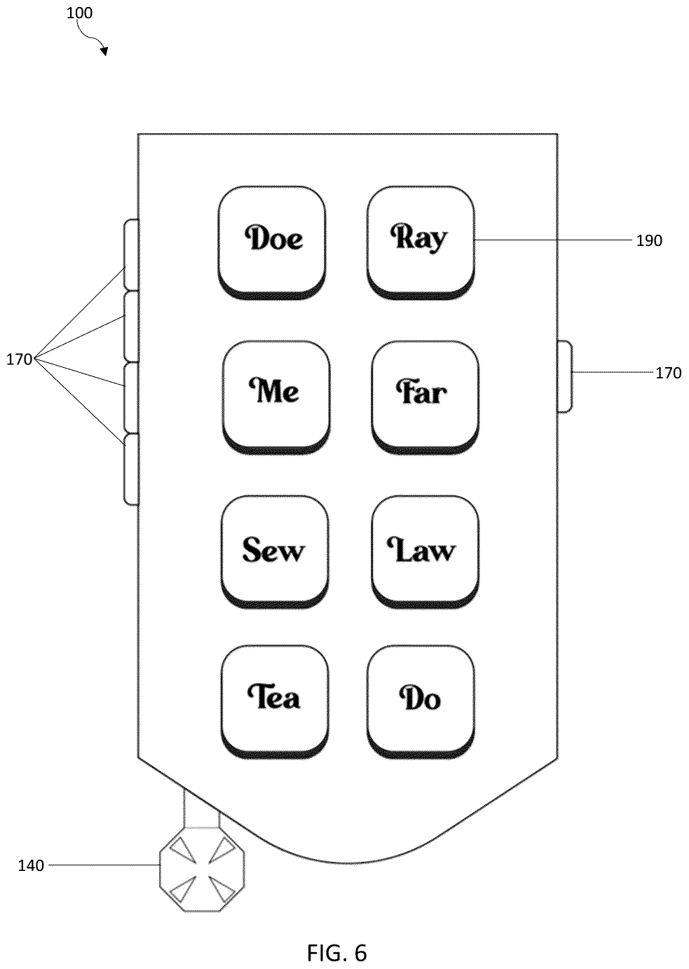

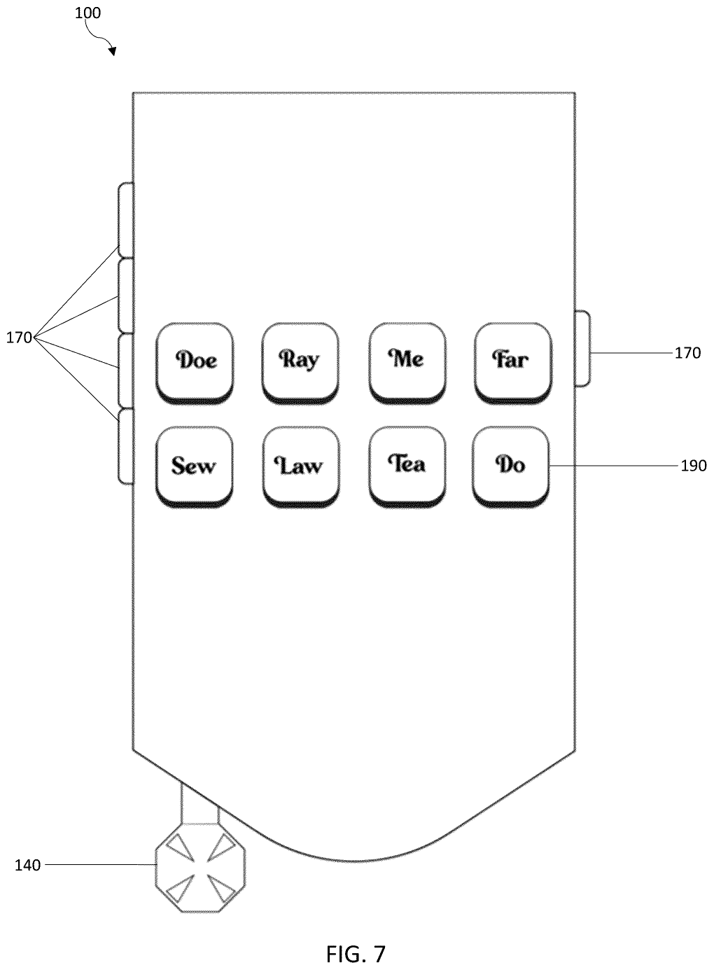

FIG. 6 illustrates the back of a mobile device 100 according to one embodiment of the invention, including the five pressure buttons 170 and the eight music keys 190. The eight music keys are labeled with mnemonic devices for remembering the notes of a musical scale and provide the user with the ability to produce music whenever the user desires. The eight music keys are hard press buttons and are split into four rows and two columns in FIG. 6. However, one of ordinary skill in the art will appreciate that any configuration of the eight music keys is possible with the present invention, and the music keys are operable to be represented on a touch screen display or in any other format. Advantageously the eight music keys 190 provide the user with an alternative method to express their emotions by composing a musical piece while also improving their musical skills. For example, an up tempo musical piece in a major key indicates the user is feeling happy, which can provide valuable information for a foster parent or guardian device that the associated foster parent or guardian is fulfilling the needs or desires of the child. A slow tempo musical piece in a minor key indicates the user is feeling sad or unmotivated. This also provides valuable information to a foster parent or guardian device, indicating that the associated foster parent or guardian needs to change their approach with the user. In one embodiment, the device 100 is operable to record the musical piece composed through the device 100 and play back the musical piece to the user. Upon completion of the musical piece, the device 100 is operable to receive an input from the user indicating that the musical piece is complete and sends the musical piece to another device connected to the device 100, such as a foster parent or guardian device. FIG. 7 illustrates an alternative embodiment of the back of the mobile device 100. According to this embodiment the eight music keys 190 are hard press buttons and are organized into two rows and four columns.

In one embodiment, the device 100 includes a microphone and a speaker. The microphone and speaker are located in the bottom rim of the mobile device 100. In one embodiment, the microphone and speaker are recessed into the bottom rim of the mobile device 100 to protect the microphone and speaker from being damaged. The microphone and speaker provide for the device to communicate with another device, such as a foster parent or guardian device, in the case of an emergency, such as an input received by the device that the child is feeling suicidal or has been badly injured. The foster parent or guardian device is operable to be an electronic device such as a smart phone, a tablet, or a laptop computer in one embodiment.

The mobile device 100 is preferably battery powered to provide for portability and ease of use. A recharging port is included on the mobile device 100, and is operable to include any charging port known in the art, such as a micro Universal Serial Bus (USB) port operable to connect with a micro USB charger.

In another embodiment, the mobile device 100 of the present invention is not operable to access a web browser or specific mobile applications, such as social media applications. The device is only allowed to access content or software pre-approved by a foster parent or guardian device in one embodiment. Another restriction on access includes restricting the access to the content or software such that the content or software is only operable to be accessed for certain periods of time or during certain times of day. By restricting the content and software that the mobile device 100 is operable to access, the present invention provides for the user of the device to remain goal-oriented and to focus on personal development.

The present invention includes a memory for storing and compiling the inputs received through the mobile device to create a record of a personality of a user. In one embodiment, the mobile device is operable to connect to a server computer or to a cloud-based platform including a memory, to store and compile the inputs received through the mobile device to create the record of the personality of the user. In one embodiment, the record of the personality of the user operable to be accessed by one or more foster parent or guardian devices. The record of the personality provides a way for a new foster parent or guardian to quickly ascertain the personality of the child and understand areas of focus, strengths, weaknesses, and improvements for the child, as well as preferences and motivators for the child.

In one embodiment, the mobile device 100 is designed to be used by foster parents and guardians to interact and communicate with foster children. The mobile device 100 of a foster parent or guardian has additional software and applications to enable a foster parent or guardian to enter the network of a mobile device 100 belonging to a foster child. When a mobile device 100 of a foster parent or guardian enters the network of a mobile device 100 belonging to a foster child, the mobile device 100 belonging to the foster parent or guardian has access to all the data recorded from the mobile device 100 belonging to a foster child. Such data includes but is not limited to audio data, visual data, empowerment bridge data, and screen time data. This data is recorded and stored to enable the device 100 to create a user profile, which is used to generate user insights. The mobile device 100 is operable to enable a foster child to communicate with a foster parent or guardian, a familial star labeled with “pride empowerment network” on the primary touch screen 180 instantly connects a foster child with a foster parent that is within their network. Similarly, if a foster parent or guardian would like to communicate with a specific foster child then the foster parent or guardian can select a familial star on the primary touch screen 180 that is labeled with the name of that specific foster child. The mobile device 100 is operable to show a foster parent or guardian a live video feed from the camera of a mobile device 100 belonging to a foster child in real time.

In one embodiment, the device 100 analyzes the data collected from the user input to generate insights into the user's feelings, morale, and/or personality. This data and these insights are recorded and stored for future analysis and understanding. In one embodiment, the device 100 is operable to aggregate a wide variety of user input, sourced from the variety of input buttons and touch screens of the device, into a user profile. The device 100 is then operable to analyze the user input data to determine the emotional state of the user. As a nonlimiting example, the device 100 receives a variety of negative inputs from the device (e.g., multiple presses of negative colors, excessive pressure from the pressure button, or simple text input that indicates a negative emotional state) and is operable to determine that the user is in a negative emotional state. However, one of ordinary skill in the art will appreciate that the device 100 is operable to determine other emotion states besides negative. In one embodiment, the data insights are automatically sent to the parent and/or guardian's device to provide the parent and/or guardian with a deeper understanding of the user. In one embodiment, the parent and/or guardian is alerted on their device when a new data insight is created.

In another embodiment, the data insights are used to generate digital photographs, messages, and/or scratch-off cards in order to motivate, encourage, and/or help the user when the data insight reveals the user is feeling down or is in another negative mental state. In one embodiment, the generate photos, images, messages, and/or starch-off cards are associated with the emotion state of the user. In one embodiment, the device 100 is operable to mint a Non-Fungible Token (NFT) of the scratch-off onto a distributed ledger (e.g., blockchain, Ethereum, ripple, etc.). In one embodiment, these digital photographs, messages, and/or scratch-off cards are unique, and each one is a NFT stored on a blockchain, such as Ethereum, as a cryptocurrency asset. In one embodiment, the created NFTs are associated with a cryptocurrency. In one embodiment, the cryptocurrency used is a previously existing currency, such as Bitcoin, Ethereum, and/or Tether. In another embodiment, a new cryptocurrency is created for these NFTs called “Foster Fry.”

In one embodiment, the device 100 includes a built-in printer and a slot for the printed items to be expelled from. In one embodiment, the built-in printer is operable to print scratch-off cards. In one embodiment, the expelling slot is located on the top of the device 100 so it does not interfere with the five pressure buttons 170 or the lock 140. In one embodiment, the printer prints encouraging photographs, messages, and/or scratch-off cards for the user when it detects, based on the data collected from the user, that the user is feeling down or is in another negative mental state. In one embodiment, the printer prints physical copies of the NFTs which are linked to their corresponding virtual NFTs using unique identifiers, such as a QR codes and/or a near-field communication (NFC) tags.

In one embodiment, the device 100 is operable to integrate with a Customer Relationship Management (CRM) system, such that the user data created by the device 100, through the plurality of input buttons and touch screens, is utilized in CRM data analysis to generate an understanding of the users of the device 100. In one embodiment, the device 100 is operable to functionally communicate with a CRM system, such that the user's emotional state is input into the CRM system.

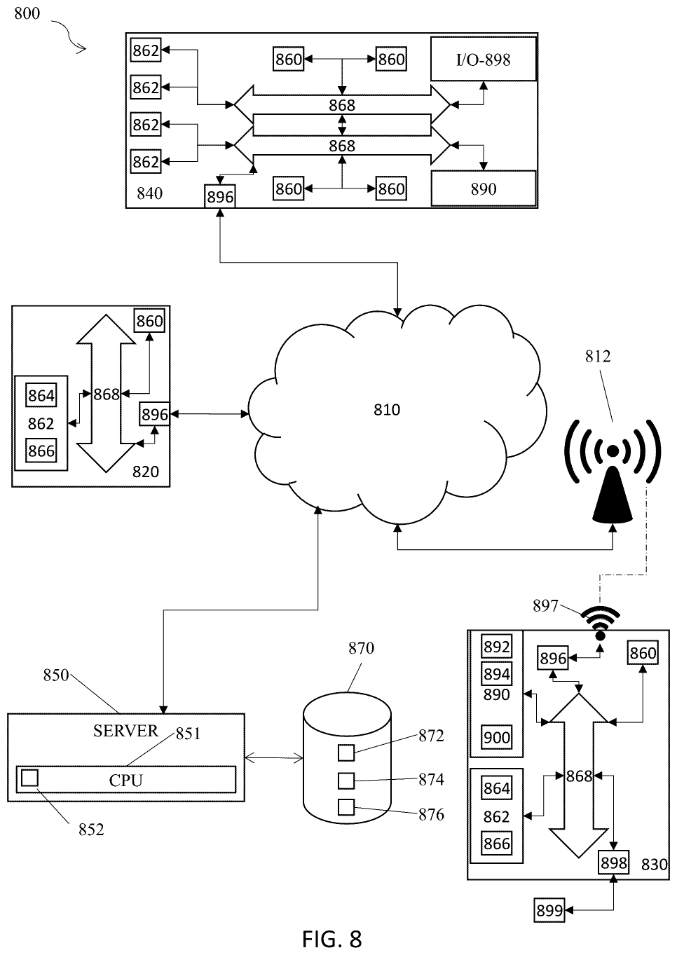

FIG. 8 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 8, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 8, is operable to include other components that are not explicitly shown in FIG. 8, or is operable to utilize an architecture completely different than that shown in FIG. 8. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. For instance, while the invention is primarily described with respect to use cases for children in foster care, the present invention is also used in a variety of other situations. In one example, individuals who have a speech impairment, such as an impairment caused by a physical accident, people who have difficulties with verbal communication due to a developmental condition such as autism, or children who are still learning to talk. Because the device enables users to express their thoughts and emotions through nonverbal methods, the device of the present invention encourages communication in these instances, and provides for personal development. In another example, the device is used in therapy to encourage users to communicate thoughts or feelings which are difficult to communicate verbally to another person such as the therapist, a parent, a spouse, or a child. The device is also operable to be utilized outside of a therapy setting in family relationships to enable someone who has a lower status (e.g., a child) to communicate with someone with a higher status (e.g., a parent). In yet another embodiment, the present invention is utilized for infirm or elderly people to provide a way for these people to connect with their families and friends and stay focused and motivated on personal development and growth. Additionally, providing a nonverbal method of communication for elderly or infirm people enables elderly or infirm people to ask for help instantaneously without feeling guilty or having to call a relative or other person who can help the elderly or infirm person. All modifications and improvements have been deleted herein for the sake of conciseness and readability but are properly within the scope of the present invention.

The invention claimed is:

1. A mobile device for enabling nonverbal communication comprising:
a housing including, a plurality of touch screens, and a plurality of input buttons;
wherein the plurality of input buttons are configured to measure an amount of pressure applied;
wherein the plurality of input button are configured to measure the number of times the plurality of input buttons are pressed;
wherein the plurality of touch screens are configured to receive touch-based input;
wherein the plurality of touch screens are configured to display an alphanumeric or alphabetical keyboard, a plurality of questions and selectable answers, a plurality of suites, photographs, images, videos, and/or text;
wherein the mobile device is operable to record the input of the user of the mobile device and associate the recorded input with an emotional state of the user through the plurality of touch screens and/or the plurality of input buttons; and
wherein the mobile device is operable to determine the development, personality, and/or preference of the user.

2. The mobile device of claim 1, wherein the plurality of touch screens include a primary touch screen, a secondary touch screen, and/or a tertiary touch screen.

3. The mobile device of claim 1, wherein the plurality of touch screens are configured to display a personal development progress of the user, a color palette, a numbered rotating dial, a musical scale, and/or at least one emoji.

4. The mobile device of claim 1, wherein the plurality of input buttons include a plurality of pressure buttons positioned on a first and second side of the mobile device where the user naturally grips the mobile device.

5. The mobile device of claim 1, wherein the plurality of input buttons include at least one hard touch button operable to record the number of times the at least one hard touch button has been pressed.

6. The mobile device of claim 1, further comprising a printer operable to print scratch-off cards.

7. The mobile device of claim 6, wherein the scratch-off cards include an encouraging message associated with the emotional state of the user.

8. The mobile device of claim 7, wherein the mobile device is operable to mint at least one Non-Fungible Token (NFT) of the scratch-off cards on a distributed ledger.

9. The mobile device of claim 1, further comprising a camera operable to capture a photograph and/or video.

10. The mobile device of claim 1, further comprising a lock operable to prevent unauthorized use of the mobile device.

11. The mobile device of claim 1, further comprising a plurality of music key buttons positioned on a back side of the mobile device.

12. A system for determining a user's emotional state comprising:
a mobile device with a processor and memory in network communication with at least one remote server;
wherein the mobile device is operable to receive input of the user through a plurality of touch screens and/or a plurality of input buttons;
wherein the mobile device is operable to collect data of the user based on the user input;
wherein the mobile device is operable to aggregate the data collected and associate the aggregated data with a user profile associated with the user;
wherein the mobile device is operable to analyze the user profile to determine an emotional state of the user based on the input of the user through the plurality of touch screens and/or the plurality of input buttons;
wherein the mobile device is operable to functionally communicate with a Customer Relationship Management (CRM) system and input the emotional state of the user into the CRM system; and
wherein the mobile device is operable to print an encouraging message associated with the emotional state of the user.

13. The system of claim 12, wherein the printed encouraging message is a scratch-off card.

14. The system of claim 13, wherein mobile device is operable to mint at least one Non-Fungible Token (NFT) of the scratch-off card on a distributed ledger.

15. The system of claim 12, wherein the plurality of touch screens are operable to display an alphanumeric keyboard, an alphabetical keyboard, the personal development progress of the user, a plurality of questions and selectable answers, a plurality of suites, photographs, images, videos, text, a color palette, a numbered rotating dial, a musical scale, and/or at least one emoji.

16. The system of claim 12, wherein the plurality of input buttons include a plurality of pressure buttons positioned on a first and second side of the mobile device where the user naturally grips the mobile device.

17. A mobile device for enabling nonverbal communication comprising:
a housing including, a plurality of touch screens, and a plurality of input buttons;
wherein the plurality of input buttons include at least one pressure button and at least one hard touch button;
wherein the plurality of touch screens include a primary touch screen, a secondary touch screen, and a tertiary touch screen;
wherein the at least one pressure button is configured to measure an amount of pressure applied to the at least one pressure button;
wherein the at least one pressure button is positioned on the housing where a user of the mobile device naturally grips the mobile device;
wherein the at least one hard touch button represents a plurality of suites;
wherein the plurality of suites include heritage, confidence, goals, teachers, lessons, experience, life, share, and/or create;
wherein the at least one hard touch button is configured to measure the number of times that at least one hard touch button is pressed;
wherein the plurality of touch screens are configured to receive touch-based input;
wherein the primary touch screen is configured to display an alphanumeric or alphabetical keyboard, personal development progress of the user of the mobile device, a plurality of questions and selectable answers, the plurality of suites, photographs, images, videos, and/or text;
wherein the secondary touch screen is configured to display an alphanumeric or alphabetical keyboard, a color palette, and/or a numbered rotating dial;
wherein the tertiary touch screen is configured to display a musical scale, at least one emoji, and/or images;
wherein the mobile device is operable to record the input of the user of the mobile representative of an emotional state of the user through the plurality of touch screens and/or the plurality of input buttons; and
wherein the mobile device is operable to determine the development, personality, and/or preference of the user.

18. The mobile device of claim 17, further comprising a printer operable to print scratch-off cards.

19. The mobile device of claim 18, wherein the scratch-off cards include an encouraging message associated with the emotional state of the user and where the mobile device is operable to mint a Non-Fungible Token (NFT) of a scratch-off card on a distributed ledger.

20. The mobile device of claim 17, further comprising a camera operable to capture a photograph and/or video.
